(19) United States
(12) Patent Application Publication
(10) Pub. No.: US 2006/0132280 A1
(43) Pub. Date: Jun. 22, 2006

(54) Positive temperature coefficient (ptc) component and method for the production thereof

(76) Inventor: Lutz Kirsten, Deutschlandsberg (AT)

Correspondence Address: FISH & RICHARDSON PC, P.O. BOX 1022, MINNEAPOLIS, MN, 55440-1022, US

(21) Appl. No.: 10/511,820

(22) PCT Filed: Apr. 14, 2003
(86) PCT No.: PCT/DE03/01264

§ 371 Date: Jun. 27, 2005

(30) Foreign Application Priority Data
Apr. 23, 2002 (DE) 10218154.3

(51) Int. Cl. H01C 7/02

(52) U.S. Cl. 338/22 R; 264/619; 264/618; 156/89.12; 338/204

(57) ABSTRACT

The invention relates to a method for the manufacture of a component with a basic body (8) comprising stacked ceramic layers (4) that are separated from one another by electrode layers (5), wherein the ceramic layers (4) contain a ceramic material that has a positive temperature coefficient at least in one part of the R/T characteristic line, with the following steps:
a) Production of a stack of layers of ceramic green sheets (1) with interposed electrode layers (5), b) Binder removal and sintering of the layer stack in an atmosphere having a lowered oxygen content in relation to air. It is possible to manufacture PTC components with small volume and low resistance.

The invention relates to a PTC component as well as to a method for production of the component.

For ceramic PTC resistors, i.e., components having a resistor with a positive temperature coefficient, so-called PTC elements, no conventionally used, temperature-stable electrodes manufactured of precious metal are suitable. These cannot form an ohmic contact between the ceramic material and the metallic electrodes. Therefore, PTC elements with (internal) electrodes manufactured of precious metal have an inadmissibly high resistance. The non-precious metals suitable for electrode material, however, generally do not withstand the sintering process that is necessary for the construction of multi-layer components.

From the publication DE 19719174 A1, a ceramic PTC resistor in multi-layer design equipped with electrode layers containing aluminum is known to the art. These layers form an ohmic contact with the ceramic material and can be sintered at temperatures of up to 1200° without incurring damage. The disadvantage in this multi-layer PTC component, however, is the fact that the aluminum partially diffuses from the electrode layers into the ceramic material, thereby impairing the component properties in the medium or long term or even making the component unusable.

From the publication DE 100 18 377 C1, a PTC component is known to the art that is a multi-layer component consisting of stacked ceramic layers and which is sintered or re-tempered in an atmosphere with high oxygen content. The PTC component contains internal electrodes with tungsten. Tungsten does withstand the sintering process.

However, sintering or subsequent tempering at high oxygen partial pressure entails the danger of the oxidation of the internal electrodes, which results in PTC components with high ohmic resistance; this is not desirable.

Sintering in an oxygenic atmosphere, on the other hand, is necessary in order to form the grain boundary-active layers of the PTC ceramic material (on the basis of doped BaTiO₃) during the cooling process. This results in the situation that at a certain temperature the resistance of the ceramic material increases erratically, depending on the precise composition of the ceramic material.

The object of the present invention is to propose a method for manufacturing a PTC component permitting the manufacture of PTC components with low volume and simultaneously with low ohmic resistance.

This object is achieved by a method according to patent claim 7. Advantageous refinements of the invention can be found in the dependent patent claims 8 through 17.

A method for the manufacture of a PTC component with the following steps is proposed:

a) Production of a stack of layers composed of ceramic green sheets with interposed electrode layers;

b) Removal of binders from and sintering of the stack of layers in an atmosphere with lowered oxygen content in relation to air.

A PTC component is to be understood to be a component with a basic body comprising stacked ceramic layers separated from one another by electrode layers, wherein the ceramic layers contain a ceramic material that has a positive temperature coefficient in at least one part of the R/T characteristic line.

Furthermore, the component is equipped with laterally attached collector electrodes, wherein the electrode layers are contacted alternately with these collector electrodes.

Due to the fact that binder removal as well as sintering are performed in an atmosphere with low oxygen content, an oxidation of the metals contained in the internal electrodes can be inhibited, which then permits the production of PTC components with improved properties.

In this context, it is particularly advantageous if the oxygen content is lowered further during sintering, when generally higher temperatures are used than for debindering.

In particular, the method according to the invention permits the production of PTC components with a volume V and an ohmic resistance R that is measured between the collector electrodes at a temperature of between 0° C. and 40° C., while V·R<600.

The production of PTC components that have simultaneously a small volume and a low ohmic resistance is thus possible, which is desirable in view of the continuing miniaturization of PTC-specific applications.

It has become evident that electrodes consisting of tungsten or containing tungsten withstand the sintering process necessary for the ceramic component while simultaneously forming a good ohmic contact with the ceramic material. During sintering, only small, if any, processes of tungsten diffusion into the ceramic material, which might impair the ceramic component properties, are observed. At the same time, tungsten has an electrical conductivity that is comparable to that of precious metals and for pure tungsten, is three times as high as that of silver, so that electrode layers with a sufficient electrical load rating can already be achieved with thinner tungsten layers. In addition, tungsten represents an economical electrode material that, for example, is substantially more economical than precious metals such as palladium or platinum.

The invention, and in particular the method for the manufacture of the component, is explained below in more detail with reference to exemplary embodiments and the respective figures. The figures serve only to illustrate the invention; they are only schematic representations and not to scale.

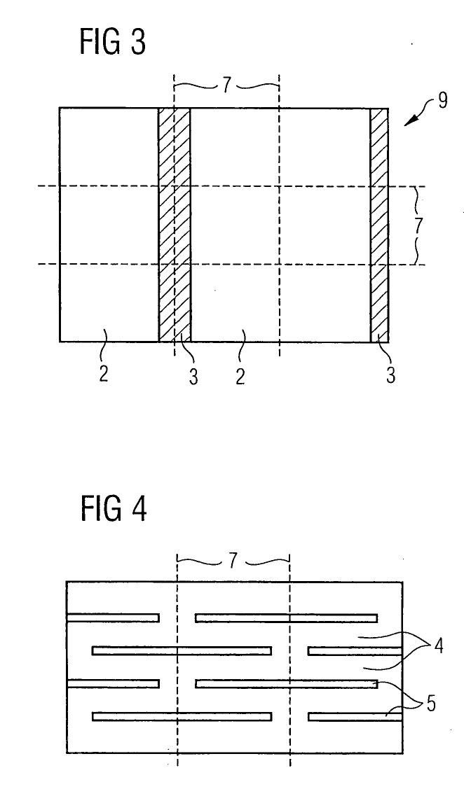

FIG. 1 shows a ceramic green sheet imprinted with an electrode layer in a perspective view;

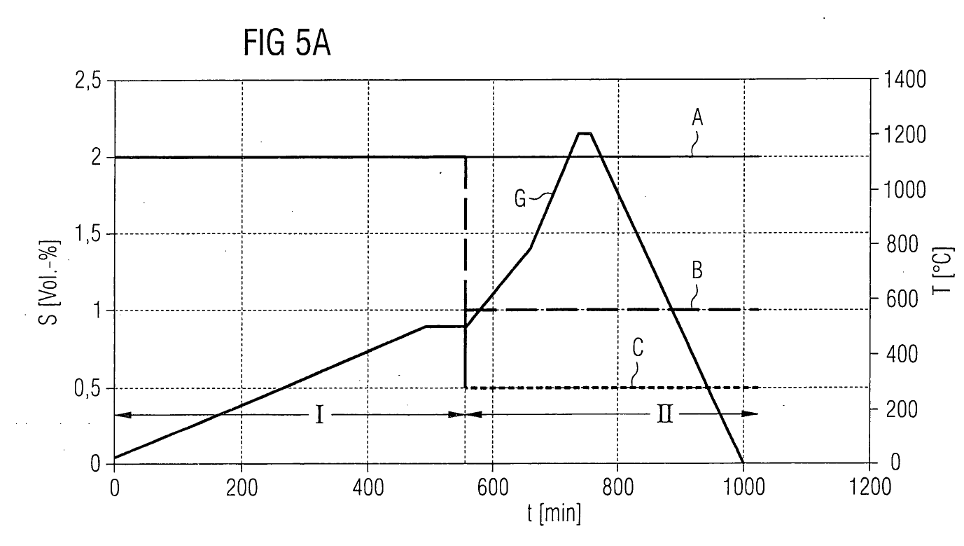

FIG. 2 shows a schematic cross section of the multi-layer component according to the invention;

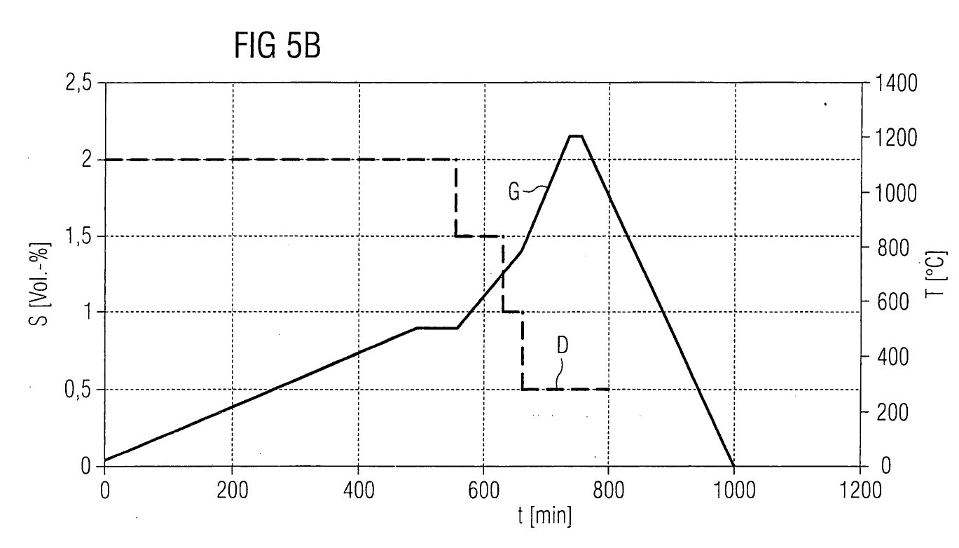

FIG. 3 shows a ceramic green sheet that can be divided into several components, with active and passive areas, in a top view;

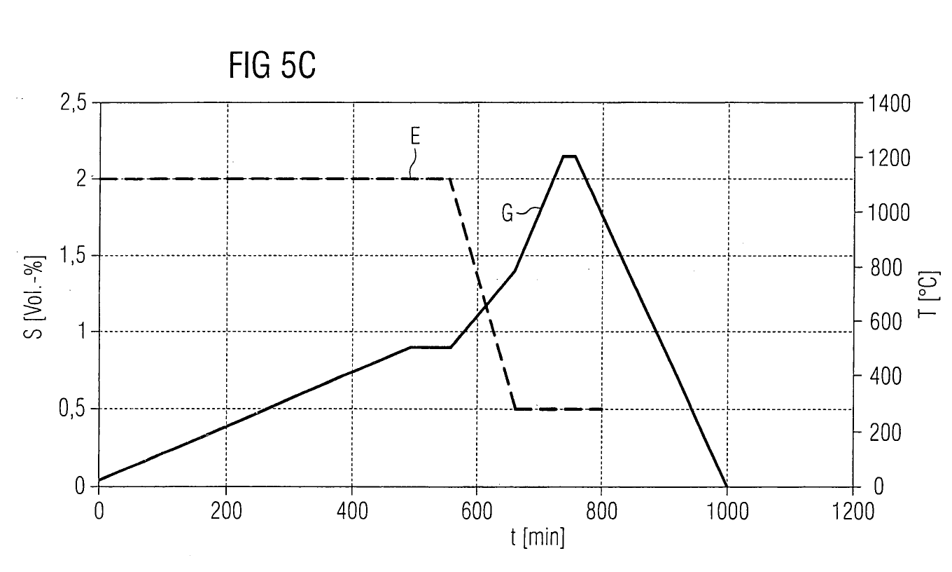

FIG. 4 shows a cross section of a stack of layers of ceramic green sheets;

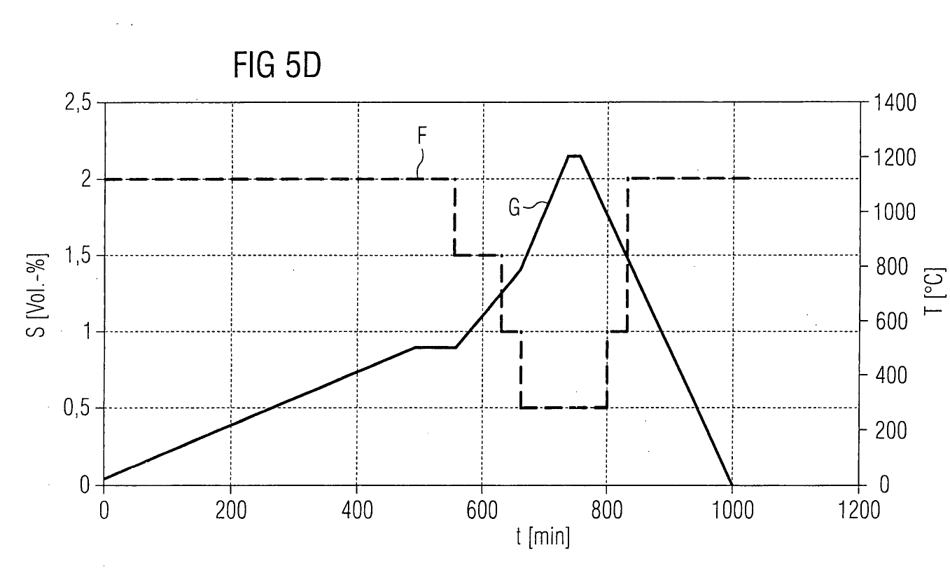

FIG. 5A each show a temperature/oxygen profile for binder removal or for sintering, through D respectively, of a stack of layers.

In order to manufacture ceramic green sheets, the ceramic base material is finely ground and mixed with a binder material to produce a homogeneous mixture. The sheet is subsequently manufactured in a desired thickness by drawing or casting.

FIG. 1 shows a green sheet 1 of this type in a perspective view. Then, an electrode paste 2 is applied onto a surface of the green sheet 1 in the area provided for the electrode.

A series of processes, in particular thick layer processes, preferably imprinting, for example by means of screen printing, are suitable for this process. A surface area not covered by electrode paste and here called passive area 3 remains, at least in the area of an edge of the green sheet 1, such as for example is shown in FIG. 1, or just in the area of one corner of the green sheet. It is also possible to apply the electrode not as a flat, but rather as a structured layer, if necessary, in an open-worked pattern.

The electrode paste 2 comprises metallic particles containing metallic tungsten or a tungsten compound for the purpose of generating the desired conductivity, ceramic particles, if necessary, which can be sintered for the purpose of adapting the shrinkage properties of the electrode paste to the ceramic material, and an organic binder, which can be burnt out for the purpose of ensuring the formability of the ceramic compound or the cohesion of the green bodies respectively. Here, particles of pure tungsten, particles of a tungsten alloy, a tungsten compound, or mixed particles of tungsten and other metals may be used. The electrode layers and thus the electrode paste can also contain additional tungsten compounds, such as tungsten carbide, tungsten nitride, or tungsten oxide (WO). The only decisive factor is that the tungsten be present in an oxidation stage less than +6, so that it will still be able to perform its function for the decomposition of the barrier layer.

With ceramic multi-layer components subject to only low mechanical stress, it is also possible to do completely without the ceramic content in the electrode paste. The tungsten content can vary within a large range, while, if necessary, the sintering conditions may have to be adapted to the composition of the electrode paste. The decomposition of the barrier layer for PTC resistor materials is achieved on a regular basis with a tungsten content of 3 and more weight percent (with reference to the metallic particles).

Subsequently, the printed green sheets 9 are stacked in a desired number to form a stack of sheets in such a way that (green) ceramic layers 1 and electrode layers 2 are stacked alternately one on the other.

During the subsequent contacting, the electrode layers are, in addition, linked to collector electrodes alternately on different sides of the component, in order to connect the individual electrodes in parallel. In this process, it is advantageous to stack first and second green sheets 9 in such a way that the imprinted electrode layers 2 have a differing orientation so that the passive areas 3 thereof point alternately in different directions. Preferably, a uniform electrode geometry is chosen for this, wherein first and second green sheets 9 differ by the fact that they are rotated at an angle of 180° in relation to one another within the stack of sheets. However, it is also possible to select a base size of greater symmetry for the component in order to make rotation by other angles than 180° possible, for example 90° when providing a square base, with the intention of achieving alternating contacting. However, it is also possible to offset the electrode pattern for every other green sheet 9 by a certain amount in relation to that of the first green sheets in such a way that each passive area 3 is located in the respective adjacent green sheet over an area imprinted with electrode paste.

Subsequently, the stack of sheets, which thanks to the binder is still flexibly resilient is brought into the desired outer form by compression and, if necessary, by cutting. The stack of sheets is then freed of the binder and sintered, either separately or in one single step.

After sintering, the individual green sheet layers develop into a monolithic ceramic component body 8, in which the individual ceramic layers 4 are firmly bonded. This firm bonding also exists at the connecting areas between ceramic material/electrode/ceramic material. FIG. 2 shows a schematic cross section of a finished multi-layer component 8 according to the invention. Ceramic layers 4 and electrode layers 5 Are alternately stacked in the body of the component. Now, collector electrodes 6, 6′ are generated at two opposite sides of the body of the component, and these are respectively in electrical contact with every other electrode layer 5. Furthermore, for example, a metallization, usually with silver, can at first be generated on the ceramic material, for example, by de-energized deposition. The latter can subsequently be reinforced by galvanic processes, such as for example by the application of a sequence of layers Ag/Ni/Sn. This enhances the possibility of soldering on printed boards. Nevertheless, other possibilities of metallization or generation of the collector electrodes 6, 6′, respectively, are also suitable, such as sputtering.

The component 8 represented in FIG. 2 has ceramic layers as end layers on both of the main surfaces. Here, for example, an un-imprinted green sheet 1 may be installed in the stack of sheets as the top layer before sintering, so that the stack does not end with an electrode layer 2. For components subject to particular mechanical stress, it is also possible to design the top and bottom ceramic layers in the stack with greater thickness than the remaining ceramic layers 4 in the stack. Here, during stacking of the stack of sheets, several non-imprinted green sheets 1 may be installed as bottom and top layers without an electrode layer and then be compressed and sintered together with the remaining stack of green sheets.

FIG. 3 shows a green sheet imprinted with an electrode pattern 2 that makes a division into several components, each with a smaller base, possible. The passive areas 3 not imprinted with electrode paste are configured in such a way that by alternately stacking first and second green sheets, the alternating offset of the electrodes in the stack can be adjusted as suitable for contacting. This can be achieved if the first and second green sheets are rotated by, for example, 180° in relation to one another or if in general first and second green sheets are arranged as offset in relation to one another in the electrode pattern. The cutting lines 7 along which the green sheet or the layer stack produced therefrom, respectively, can be divided into individual components are shown as interrupted lines. However, it is also possible to have electrode patterns in which the cuts for the division into individual components are laid out in such a way that no electrode layer needs to be cut through. Every other electrode layer however can then be contacted from the edge of the stack. For this purpose, if necessary, the stacks are ground after being divided into individual components and after sintering but before attachment of the collector electrodes 6, 6′, in order to expose the contacting electrode layers.

FIG. 4 shows a schematic cross section of a stack of layers produced in this manner. It becomes evident that components are formed of which each has the desired offset of the electrodes 4 when the layer stack is divided into individual components along the cutting lines 7. The division of a stack of sheets of this type comprising several component base sizes into individual sheet stacks of the desired component base size preferably occurs after compressing the stacks of sheets, for example, by cutting or punching. Subsequently, the stacks of sheets are sintered. However, it is also possible to first sinter the stack of sheets comprising several component base sizes and only then to divide it into individual components by sawing the sintered ceramic pieces. Finally, collector electrodes 6 are again applied.

A PTC component according to the invention consists of a barium titanate ceramic material of the general composition (Ba, Ca, Sr, Pb)TiO₃ which is doped with donators and/or acceptors, for example with manganese and yttrium.

The component may, for example, comprise 5 to 20 or more ceramic layers along with the respective electrode layers, but has at least two internal electrode layers. The ceramic layers normally each have a thickness of 30 through 200 μm. They may, however, also be of greater or smaller layer thickness.

The exterior dimension of a PTC component in the multi-layer design according to the invention may vary, but for components that can be processed within the framework of SMD it is normally in the range of only few millimeters. A suitable size is, for example, the size of design 2220 known from capacitors. Geometries and component tolerances in this respect result from the CECC 32101-801 standard or from other standards. Nevertheless, the PTC component may also be still smaller.

FIGS. 5A through D each show an equal temperature profile combined with differing oxygen profiles. The temperature evolution is indicated by the continuous curve G. The area I between the times 0 and 260 minutes is the area of binder removal. The temperature rises evenly from 20° C. to 500° C. In this time range, the oxygen content is 2 vol. %.

Adjacent to the area I lies area II, beginning at the time of 280 minutes and ending at the time of 500 minutes. In this area II, the layer stack is sintered. In this process, the temperature is, starting from the binder removal end temperature of 500° C., further increased until it reaches a value of 1200° C., after which it is again reduced.

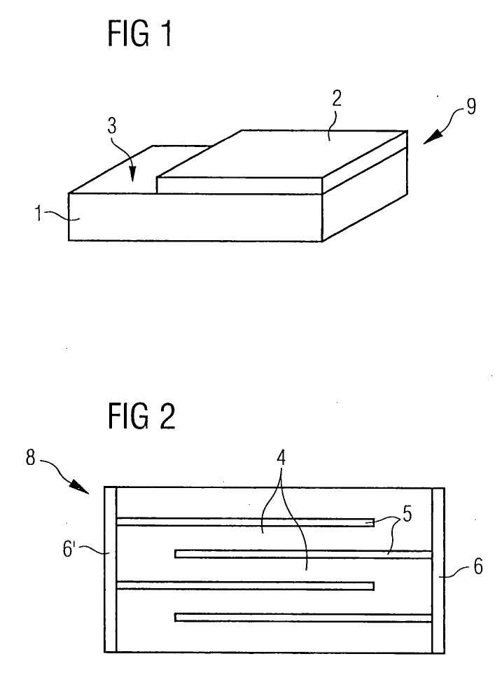

During sintering (area II), the oxygen content may be kept either at 2 vol. %, i.e., at the value of binder removal (curve A in FIG. 5A), or the oxygen content is, after binder removal terminated, decreased to a lower value, such as 1 vol. % (curve B in FIG. 5A) or 0.5 vol. % (curve C in FIG. 5A).

Another possibility is the step-by-step decrease of the oxygen content in the direction opposite to the rising temperature (see curve D in FIG. 5 B). In FIG. 5 C, another variant is shown wherein the oxygen content according to curve E is continuously decreased during sintering down to a value of 0.5 vol. %.

Furthermore, it may be advantageous, as shown in FIG. 5 D, curve F, to decrease the oxygen content with rising temperature and, after exceeding the maximum temperature of 1200° C., to allow it to increase again step by step. This has the advantage that more oxygen will again be available for the ceramic material when temperatures are lower than the maximum sintering temperature, which improves the properties of the ceramic. This promotes better formation of the grain boundary-active layers of the PTC ceramic material.

Furthermore, it is advantageous if the processes of binder removal and sintering are performed immediately one after the other, without lowering the temperature to ambient temperature or below the maximum binder removal temperature of 500° C. in between. This results in an shortening of the processing time as well as in lower oxidation of tungsten.

Preferably, the processes of binder removal and sintering are performed in an atmosphere representing a mixture of nitrogen or noble gas or another inert gas with air or oxygen. For example, nitrogen and air may be mixed in such a way that it leads to an oxygen content of 2 vol. % in the atmosphere. Up to a temperature of 500° C., the layer stacks are freed of binder, and sintering is performed in the same atmosphere. Barium titanate ceramic materials, for example, may be used; sintering is performed at the temperatures normally used for this process.

In Table 1 below, component resistances of PTC components manufactured with the method according to the invention in design 1210 with 23 electrodes are shown as a function of the oxygen content during sintering and compared with sintering in air.

TABLE 1

| Oxygen content in vol. % | Component resistance in Ω |
|---|---|
| 21 (air) | 40 |
| 7 | 25 |
| 1 | 9 |
| 0.5 | 2.5 |

This makes clear how the resistance of the component can be decreased by reducing the oxygen content. This is the consequence of decreased oxidation of the metallic material contained in the internal electrodes.

By using the method according to the invention, it is possible to manufacture PTC components with small volume and with simultaneously low electrical resistance.

Table 2 below shows PTC component resistances as a function of the volume of the PTC component.

TABLE 2

| | | | | Obtainable | | |
|---|---|---|---|---|---|---|
| | Length | Width | Height | component | Volume | V · R |
| De- | in | in | in | resistance | in | in |
| sign | mm | mm | mm | in Ohm | mm³ | Ohm · mm³ |
| 0805 | 1.25 | 1.0 | 2.0 | <100 | 2.5 | <250 |
| 0805 | 1.25 | 1.7 | 2.0 | <100 | 4.25 | <425 |
| 1206 | 1.6 | 1.0 | 3.2 | <50 | 5.12 | <256 |
| 1206 | 1.6 | 1.7 | 3.2 | <50 | 8.7 | <435 |
| 1210 | 2.5 | 1.0 | 3.2 | <30 | 8.0 | <240 |
| 1210 | 2.5 | 2.0 | 3.2 | <30 | 16.0 | <480 |
| 1812 | 3.2 | 1.0 | 4.5 | <20 | 14.4 | <288 |
| 1812 | 3.2 | 2.0 | 4.5 | <20 | 28.8 | <576 |
| 2220 | 5.0 | 1.0 | 5.7 | <10 | 28.5 | <285 |
| 2220 | 5.0 | 2.0 | 5.7 | <10 | 57.0 | <570 |

1. An electrical component having a positive temperature coefficient, the electrical component comprising:
a base comprised of ceramic layers and electrode layers, the electrode layers separating adjacent ceramic layers, ceramic layers comprising a ceramic material that has a positive temperature coefficient in at least one part of an R/T characteristic curve; and
a first collector electrode attached to a first side of the electrical component and a second collector electrode attached to a second side of the electrical component, wherein the first collector electrode and the second collector electrode contact alternate electrode layers;
wherein the electrical component has a volume V and a resistance R, the resistance R being measured between collector electrodes at a temperature of between 0° C. and 40° C.; and
wherein V·R<600 Ω·mm³.

2. The electrical component of claim 1, wherein the ceramic material comprises ceramic green sheets, the ceramic green sheets being sintered with the electrode layers to form the base.

3. The electrical component of claim 1, wherein at least some of the electrode layers comprise tungsten.

4. The electrical component of claim 1, wherein at least some of the electrode layers comprise tungsten carbide.

5. The electrical component of claim 1, wherein the electrode layers comprise WO.

6. The electrical component of claim 1, wherein at least some of the electrode layers comprise a tungsten compound that contains tungsten having a valence less than +6.

7. A method of manufacturing an electrical component having a positive temperature coefficient, the electrical component comprising:
(a) a base comprised of ceramic layers and electrode layers, the electrode layers separating adjacent ceramic layers, the ceramic layers comprising a ceramic material that has a positive temperature coefficient in at least one part of an R/T characteristic curve, and (b) a first collector electrode attached to a first side of the electrical component and a second collector electrode attached to a second side of the electrical component, wherein the first collector electrode and the second collector electrode contact alternate electrode layers, wherein the electrical component has a volume V and a resistance R, the resistance R being measured between collector electrodes at a temperature of between 0° C. and 40° C., and wherein V·R<600 Ω·mm³.
wherein the method comprises:
forming the base using ceramic green sheets interspersed with the electrode layers, the ceramic green sheets comprising the ceramic layers; and
removing a binder from, and sintering, the base in an environment having an oxygen content that is lower than an oxygen content of air.

8. The method according to The method of claim 7, wherein the oxygen content of the environment is less than 8 vol. %.

9. The method of claim 7, wherein removing the binder is performed at a temperature of <600° C.

10. The method of claim 7, wherein sintering is performed in a temperature interval of between 1000° C. and 1200° C.

11. The method of claim 7, further comprising, after removing the binder keeping a temperature of the base at a value that corresponds to a binder removing temperature at least until sintering is completed.

12. The method of claim 7, wherein removing the binder is performed in an environment with an oxygen content of between 0.5 and <8 vol. %.

13. The method of claim 7, wherein sintering is performed in an environment with an oxygen content that corresponds to an oxygen content that is present during removal of the binder.

14. The method of claim 7, wherein sintering is performed in an environment with an oxygen content of between 0.1 and 5 vol. %.

15. The method of claim 7, wherein the oxygen content of the environment is decreased after the binder is removed.

16. The method of claim 7, wherein the oxygen content of the environment is reduced continuously after the binder is removed.

17. The method of claim 7, wherein after the binder is removed, the oxygen content of the environment decreases with increasing temperature.

18. The method of claim 7, wherein the oxygen content of the environment increases after a maximum sintering temperature is exceeded.

19. A SMD-capable PTC resistor element comprising the electrical component of claim 1.
